(19) United States
(12) Patent Application Publication
(10) Pub. No.: US 2007/0013700 A1
(43) Pub. Date: Jan. 18, 2007

(54) Mobile communication terminal having function of animating input characters

(75) Inventors: Sang Min Yoon, Seongnam City (KR); Shin Woong Park, Seongnam City (KR); Choong Hwan Lee, Seongnam City (KR); Duk Ho Chang, Seongnam City (KR)

Correspondence Address: BIRCH STEWART KOLASCH & BIRCH, PO BOX 747, FALLS CHURCH, VA, 22040-0747, US

(73) Assignee: Digitalaria Co., Ltd.

(21) Appl. No.: 11/480,839

(22) Filed: Jul. 6, 2006

(30) Foreign Application Priority Data
Jul. 13, 2005 (KR) 10-2005-63457

(51) Int. Cl. G06T 15/70

(52) U.S. Cl. 345/473

(57) ABSTRACT

Disclosed herein is a mobile communication terminal having a function of animating input characters. The mobile communication terminal includes memory, device hardware, a device Operation System (OS), an animation engine, and content. The memory stores character font image data and animation data capable of providing the animation effect of animating characters. The device hardware receives key input from a user and informs the device OS of input characters. The device OS transfers information about the received characters to the animation engine. The animation engine analyzes the content and extracts information about the locations of images from the content. The content creates frame variation information, indicating the variations of various objects on the screen as to implement the animation effects, and transfers the frame variation information to the animation engine. The animation engine creates all frames of the screen based on the frame variation information, transfers the frames to the device OS, and sequentially displays the frames on the screen via the device hardware.

### BACKGROUND OF THE INVENTION

1. Field of the Invention

The present invention relates to a method of providing animation effects to input characters in an input device for inputting characters (including Arabic numerals and special symbols), and a mobile communication terminal using the method.

2. Description of the Related Art

If characters input by a user through a character input device are animated as if the user were writing the characters on a screen in the case where a phone number is input to make a call or characters are input to send a Short Message Service (SMS) message in a mobile phone or Personal Digital Assistant (PDA), the user can have a visually realistic experience.

In order to implement such effects, a new technical method of realizing effective interworking among a mobile phone/PDA Operating System (OS), an animation engine, animation content, and a display device, other than an existing method of simply displaying input characters on a screen, is required. Furthermore, a method of efficiently supporting the method using the limited range of hardware resources is required.

Meanwhile, the Korean alphabet based on current Unicode 2.0 includes a total of 19×21×28=11,172 characters, which are composed of 19 initial consonants, 21 medial vowels and 28 final consonants (including cases having no final consonant). The completed Korean alphabet code performs presentation using only 2300 of the 11,172 characters.

In order to animate such input characters, assuming that 1 KB of animation data is required for each character in order to animate the character along the strokes of the character at the time of inputting the character, a considerably large amount of memory corresponding to 11.172 MB is required to animate all of the characters of Unicode 2.0. In the case of the completed Korean alphabet code, a relatively large amount of memory space, corresponding to 2.3 MB, is still required.

However, mobile communication terminals, such as mobile phones or PDAs, have a small amount of memory, typically less than several MBs, thus it is either impossible or burdensome to store all of the large amount of animation data for Unicode 2.0 or the completed Korean alphabet code in the memory of the mobile communication terminals.

Accordingly, in order to animate characters input in small-sized portable devices such as mobile phones, a special scheme for significantly reducing the amount of animation data is required.

### SUMMARY OF THE INVENTION

Accordingly, the present invention has been made keeping in mind the above problems occurring in the prior art, and an object of the present invention is to provide a mobile communication terminal to which a method of providing an animation effect to input characters is applied.

Furthermore, another object of the present invention is to provide a mobile communication terminal to which both the animation provision method and a method capable of significantly reducing the amount of required animation data are applied.

In order to accomplish the above object, the present invention provides a mobile communication terminal having a function of animating input characters and displaying the characters on a screen, including memory, device hardware, a device OS, an animation engine, and content; wherein the memory stores character font image data and animation data capable of providing an animation effect of animating characters; wherein the device hardware receives key input from a user and informs the device OS of input characters; wherein the device OS transfers information about the received characters to the animation engine; wherein the animation engine analyzes the content and extracts information about locations of images from the content; wherein the content creates frame variation information, indicating the variations of various objects on the screen so as to implement animation effects, and transfers the frame variation information to the animation engine; and wherein the animation engine creates all frames of the screen based on the frame variation information, transfers the frames to the device OS, and sequentially displays the frames on the screen via the device hardware.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a process of animating English characters according to the present invention;

FIG. 2 is a flowchart showing a process of animating Korean alphabet characters according to the present invention;

FIG. 3 is a diagram showing the overall construction of a mobile phone to which the present invention is applied;

FIG. 4 is a diagram illustrating the function of an animation engine; and

FIG. 5 is a diagram showing the sequence of animation frames.

### DESCRIPTION OF THE PREFERRED EMBODIMENTS

Reference now should be made to the drawings, in which the same reference numerals are used throughout the different drawings to designate the same or similar components.

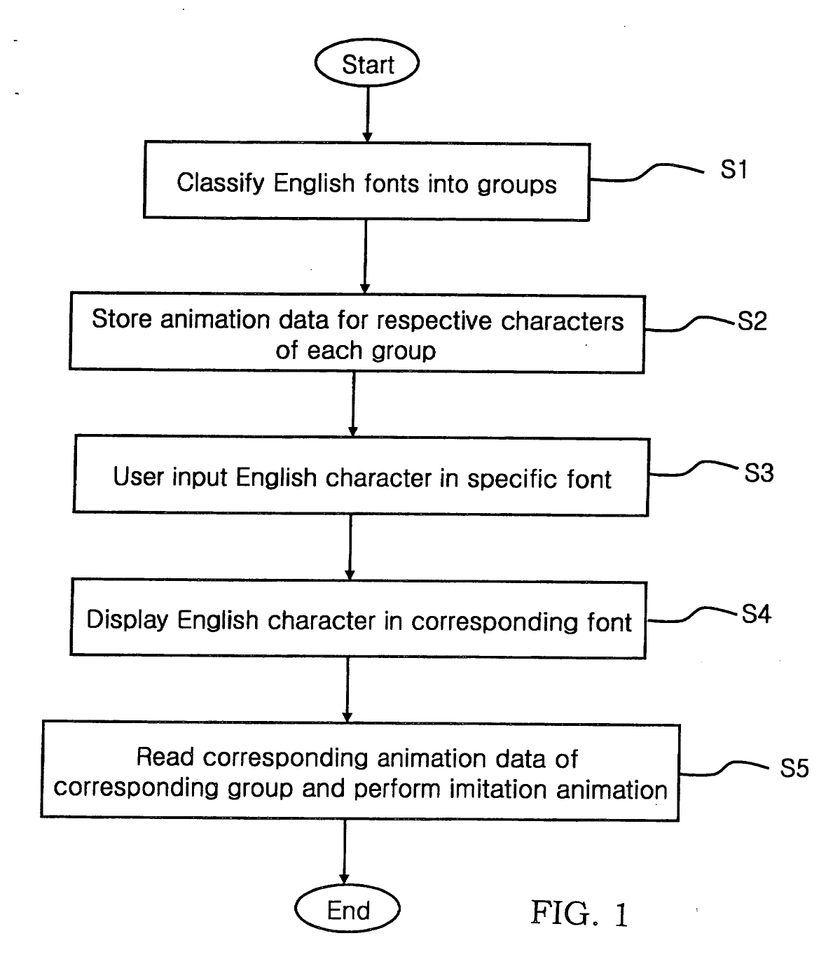

The principle of the present invention is described using an example with reference to FIG. 1 below.

If, when a user inputs the italic character “A” via the character input device, the italic character “A” is displayed on the screen of a character input device and, at the same time, a imitation animation (an animation in which a writing tool imitates the writing of the italic character “A” without displaying the strokes of the character on a screen) is performed along lines similar to the strokes of the italic character “A”, it seems to the user as though the input device were writing the character on the screen.

Meanwhile, even though, for corresponding characters in similar fonts, such as the Gothic font and the Gulim font, corresponding character's font are displayed and, at the same time, the same imitation animation (in this animation, a character is not actually written on a screen, but only a imitation of writing the character is made) is performed, it seems to the user as though the input device were writing a character in the same font.

As a result, as shown in FIG. 1, a scheme in which a user does not notice the difference even if the same imitation is made for similar fonts may be used. English fonts are classified into several groups at step S1. Animation data corresponding to the respective English characters of each group is stored in the memory of an input device at step S2. When the user inputs an English character in a specific font via the input device at step S3, a character, which is stored in the memory of the input device and corresponds to the English character in the corresponding font, is displayed on a screen at step S4 and, at the same time, animation data, which corresponds to the corresponding character of the group to which the font of the English character belongs, is read from the memory of the input device and a imitation animation is executed at step S5. At this time, the user feels as if the input device were writing the English character. In this case, if English fonts, for example, 50 fonts, are classified into several groups, for example, 5 groups, only several sets (5 sets) of animation data are required, therefore the amount of animation data to be stored is significantly reduced. The same principle is applicable to Arabic numerals or the Korean alphabet.

Furthermore, such an optical illusion is effectively achieved in a mobile communication terminal in which the size of characters is small. Furthermore, it is more effective to use a method of displaying a pen (or a similar object, such as a finger, capable of representing a writing action) at the time of imitation animation and giving an indication as if a user were writing characters using a pen, or to use a method of displaying previously created special content (a substrate, such as a Post-It, on which a character are written) on a screen when the user inputs characters.

Meanwhile, unlike English characters or Arabic numerals, the Korean alphabet is characterized in that character “ [symbol] ” in the same font has significantly different shapes depending on whether it is used as an initial consonant or a final consonant, and the character “ [symbol] ” used as an initial consonant has significantly different shapes depending on subsequent medial vowels and final consonants. Accordingly, for the Korean alphabet, not only the classification of fonts into several groups but also the provision for different character shapes depending on the locations of initial consonants, medial vowels and final consonants, and depending on subsequent medial vowels and final consonants are required.

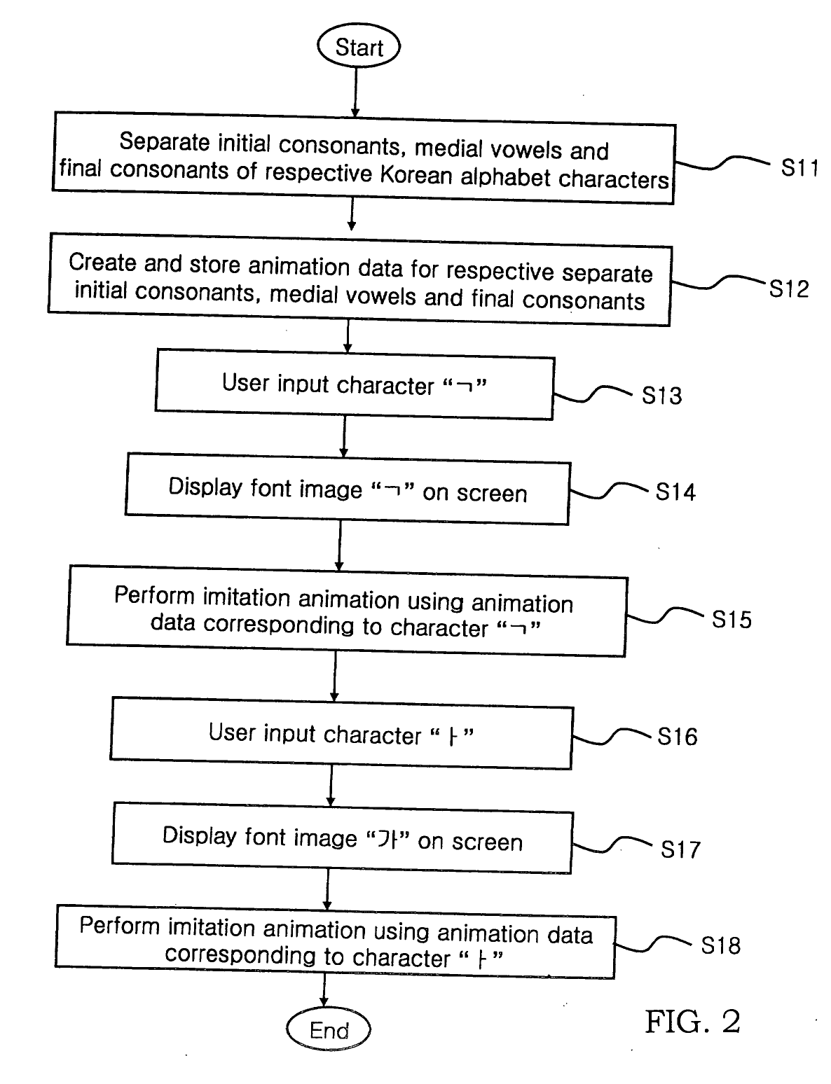

In order to solve such problems with the Korean alphabet, the present invention, as shown in FIG. 2, separates the initial consonants, medial vowels and final consonants of respective Korean alphabet characters at step S11, and animation data available for the initial consonants, medial vowels and final consonants of the Korean alphabet characters is created and stored in the memory of the input device at step S12.

For example, in the case of the Korean alphabet, even the same initial consonant “ [symbol] ” has different shapes in characters “ [symbol] ”, “ [symbol] ”, “ [symbol] ”, “ [symbol] ” and “ [symbol] ”, therefore 8 sets for an initial consonant, 4 sets for a medial vowel and 4 sets for a final consonant are required for the character “ [symbol] ”.

The Unicode Korean alphabet 2.0 requires storage capacity corresponding to 11,172 characters. If the above method is used and 8 sets for initial consonants, 4 sets for medial vowels and 4 sets for final consonants are stored, only a storage space for animation data corresponding to 19×8+21×4+28×4=384 characters is required. As a result, the storage space for animation data is reduced to about 1/30 of its original size. Furthermore, in the case where various Korean alphabet fonts can be used, the fonts are classified into groups according to shape and animation data corresponding to 384×N (384 characters×the number of groups N) is required.

When the character “ [symbol] ” is first input to display “ [symbol] ” at step S13, a font image corresponding to “ [symbol] ” is displayed on the screen at step S14 and an animation imitating the writing of “ [symbol] ” on a screen is performed using animation data corresponding to “ [symbol] ” at step S15. Thereafter, when the character “ [symbol] ” is input at step S16, a font image corresponding to the character “ [symbol] ” is displayed on the screen at step S17 and an animation imitation the writing of “ [symbol] ” on a screen is performed at step S18. As a results, a font image corresponding to the character “ [symbol] ” is displayed on a screen and an animation imitating the writing of the character “ [symbol] ” on the screen is performed.

By doing this, the Korean alphabet character input by the user is animated, therefore a screen showing a imitation of writing of the character is displayed.

Meanwhile, although 8 sets of animation data, 4 sets of animation data and 4 sets of animation data are described as being respectively used for initial consonants, for medial vowels and for final consonants, a method of using the same animation data for various initial consonants “ [symbol] ” and the same animation data for various final consonants “ [symbol] ”, that is, a method of respectively using three sets of animation data for initial consonants, for medial vowels and for final consonants (that is, only 19+21+28=68 pieces of animation data) may be used, since the animation of the present invention is not an animation of actually writing characters but an animation of imitating the writing of characters, thereby further reducing the number of pieces of animation data.

Furthermore, when the size of characters is small, as in the case of the input of the SMS message of a mobile phone, a method of using the same animation data for both initial and final consonant characters “ [symbol] ”, that is, a method of using one set of animation data (that is, 19+21=40 pieces of animation data) may be used, thereby further reducing the number of pieces of animation data.

In this case, since for initial consonants, animation data is maintained for only 19 characters “ [symbol] ”, “ [symbol] ”, “ [symbol] ”, ˜, “ [symbol] ”, a single piece of animation data is maintained for each initial consonant, regardless of variation in medial vowel, as in characters “ [symbol] ”, “ [symbol] ”, and “ [symbol] ”. Also for final consonants, not different pieces of animation data, but the animation data for each initial consonant character, is used, regardless of variation in final consonant, as in characters “ [symbol] ”, “ [symbol] ”, “ [symbol] ”, and “ [symbol] ”.

Furthermore, if imitation animation is applied to the last among the initial consonant, medial vowel and final consonant, the visual effect in which an animation seems to be performed along the strokes of characters can be implemented.

Meanwhile, when animation data, which is optimized based on the complexity of an animation effect, the resolution and size of a display device and the performance of a system, is stored, storage space for the animation data of the present invention can be optimized.

Furthermore, with respect to animation data corresponding to respective characters, path animation based on simple straight lines requires a small amount of data because only data about inflection points constituting the structures of respective characters is required, and flexible and smooth animation requires a large amount of data because curve data composed of the control points of curves and parameters constituting the structures of respective characters must be constructed.

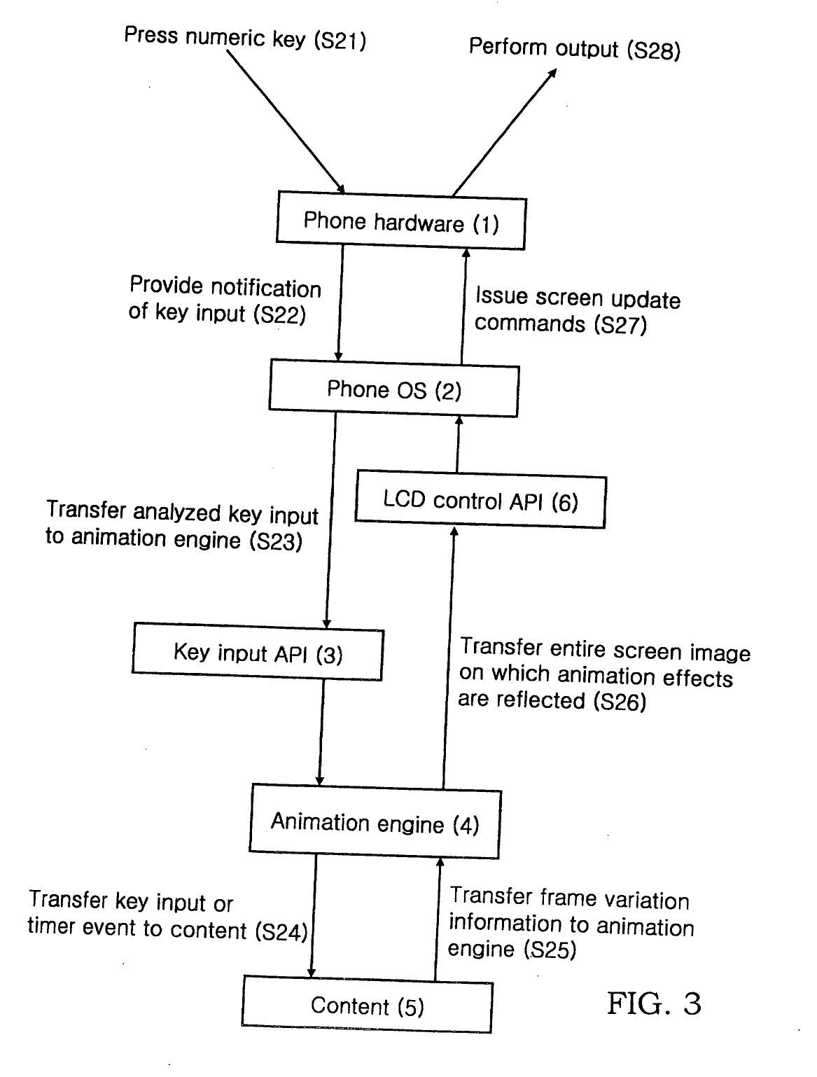

With reference to FIGS. 3 to 5, in the case where the above-described principle of the present invention is applied to a mobile phone and a phone number is input, a process of implementing animation on the screen of the mobile phone is described. The Korean alphabet and English characters are also implemented in the same way.

FIG. 3 shows the overall construction of the mobile phone to which the present invention is applied.

When the user presses a number key to make a call or input a number included in an SMS message at step S21, phone hardware 1 transfers this key input to a phone Operating System (OS) 2 at step S22.

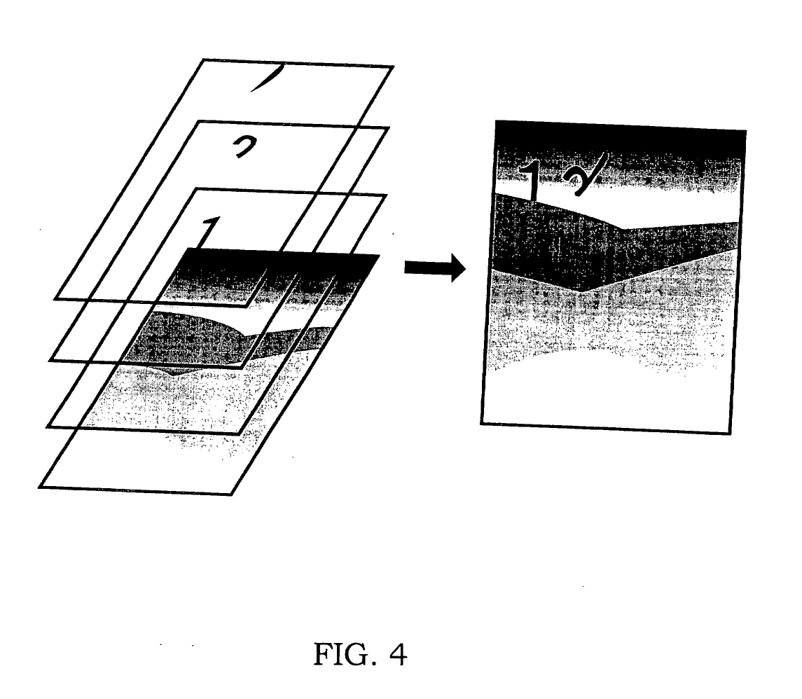

The phone OS 2 analyzes the key input, and transfers information about the analyzed key input to an animation engine 4 via a key input Application Program Interface (API) 3 at step S23. In this case, various animation engines (for example, Macromedia's FLASH or various animation engines supporting SVG Scalable Vector Graphic) may be used as the animation engine 4. The animation engine 4 functions to interpret content 5. When a number “2” is finally input through key input after the number “1” has been input and the content 5 has been interpreted, information about the locations of each image (refer to the left view of FIG. 4) is determined in order to perform an animation imitating the writing of the number “2” using a pen. When these pieces of information are compiled and output to the screen of the mobile phone, the image shown in the right view of FIG. 4 is output to the screen. A pen is represented in the top of the left view of FIG. 4.

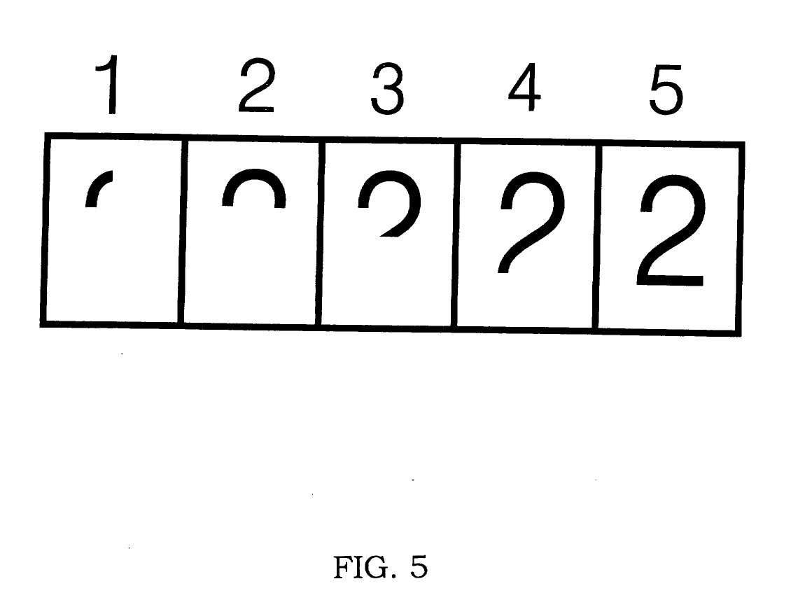

Now, the animation engine 4 transfers the key input or a timer event to the content 5 at step S24. The content 5 transfers information about variations of various objects on the screen according to the key input or timer event to animation engine 4 at step S25. For example, when the user input number “2”, the content 5 creates the information about the variations in the screen of respective frames (steps 1 to 5 of FIG. 5), indicating the variations of various objects on the screen, based on the animation data stored in memory so as to perform an animation imitating the writing of the number “2”, and transfers the information to the animation engine 4. Although, in FIG. 5, steps 1 to 5 of animating the number “2” are illustrated using solid lines for ease of illustration, the solid lines of FIG. 5 illustrate only the strokes of the imitation animation of the number “2” in each frame, but they are not displayed on the screen, since the animation of the present invention is a imitation animation.

Thereafter, the animation engine 4 creates all of the screen frames to which animation effects are added, based on the transferred information about frame variations to animate the number “2”, and sequentially transfers the frames to the phone OS 2 via a Liquid Crystal Display (LCD) control API 6 at step S26. Thereafter, the phone OS 2 sequentially issues screen update commands to the phone hardware 1 at step S27. When the phone hardware 1 sequentially outputs the respective frames to the screen at step S28, a font image corresponding to the number “2” is displayed on a desktop screen, and the number “2” is gradually and imitatively animated, as illustrated in FIG. 5.

Using the above-described present invention, a character input device and a user interface capable of achieving the effects of animation of the writing of characters, which are input by the user, on a screen while reducing the amount of animation data can be provided.

Furthermore, since the system implemented via the present invention does not need to store all of the animation data about all of the characters necessary for the input of characters but stores only animation data about characters input last, it is easy to apply the present invention to mobile communication terminals and portable devices having a low amount of memory and low computational capacity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile communication terminal having a function of animating input characters and displaying the animated characters on a screen, comprising:
memory, device hardware, a device Operating System (OS), an animation engine, and content;
wherein the memory stores character font image data and animation data capable of providing an animation effect of animating characters;
wherein the device hardware receives key input from a user and informs the device OS of input characters;
wherein the device OS transfers information about the received characters to the animation engine;
wherein the animation engine analyzes the content and extracts information about locations of images from the content;
wherein the content creates frame variation information, indicating variations of various objects on the screen so as to implement animation effects, and transfers the frame variation information to the animation engine; and
wherein the animation engine creates all frames of the screen based on the frame variation information, transfers the frames to the device OS, and sequentially displays the frames on the screen via the device hardware.

2. The mobile communication terminal as set forth in claim 1, wherein:
the animation is a imitation animation that imitates writing of the characters;
the imitation animation creates at least one set of animation data for each set of characters in consideration of differences in character shape depending on fonts of characters, locations of these characters, that is, whether these characters are first consonants, medial vowels or final consonants, or subsequent medial vowels and final consonants of these characters, and stores the sets of animation data in the memory; and
whenever the user inputs a character, an appropriate set of animation data is selected from the stored sets of animation data in consideration of a font of the input character, a location of the input character, that is, whether the input character is a first consonant, a medial vowel or a final consonant, or a subsequent medial vowel or final consonant of the input character, and animation data corresponding to the input character is read from the memory and used to create the frame variation information.

3. The mobile communication terminal as set forth in claim 2, wherein different sets of animation data are used for the initial consonants, medial vowels and final consonants of the respective characters in consideration of locations of first consonants, medial vowels and final consonants of these characters, or medial vowels and final consonants subsequent to these characters.

4. The mobile communication terminal as set forth in claim 2, wherein three sets of animation data are respectively used for the initial consonants, medial vowels and final consonants of the respective characters in consideration of locations of the first consonants, medial vowels and final consonants of these characters, or medial vowels and final consonants subsequent to these characters.

5. The mobile communication terminal as set forth in claim 2, wherein the number of sets of animation data is determined depending on complexity of the animation effects, a resolution and size of a display device, or performance of the terminal.

6. The mobile communication terminal as set forth in claim 2, wherein the simulation animation displays a specific tool on the screen and causes the specific implement to imitate writing of the characters.

7. The mobile communication terminal as set forth in claim 1, wherein the animation engine is an engine that supports a Flash format.

8. The mobile communication terminal as set forth in claim 1, wherein the animation engine is an engine that supports a Scalable Vector Graphic (SVG) format.
